(19) United States
(12) Patent Application Publication
(10) Pub. No.: US 2026/0195691 A1
(43) Pub. Date: Jul. 9, 2026

(54) CONTEXT-BASED STRATEGY GENERATION AND IMPLEMENTATION

(71) Applicant: Landbase, Inc., San Francisco, CA (US)

(72) Inventor: Hua Gao, Sunnyvale, CA (US)

(21) Appl. No.: 19/439,150

(22) Filed: Jan. 2, 2026

Related U.S. Application Data
(60) Provisional application No. 63/742,325, filed on Jan. 6, 2025.

(51) Int. Cl. G06Q 10/0637; G06N 20/00

(52) U.S. Cl. CPC G06Q 10/0637; G06N 20/00

(57) ABSTRACT

An embodiment includes generating, using a trained planning model and a context, an instruction implementing each candidate action in a plurality of candidate actions, the plurality of candidate actions selected by the trained planning model from a plurality of predefined actions. An embodiment includes generating, from the instruction, using a trained generator model and the context, an implementation of each instruction. An embodiment includes scoring, using a trained reward model, each candidate action in the plurality of candidate actions, the scoring resulting in a plurality of scored candidate actions. An embodiment includes selecting, from the plurality of scored candidate actions, a scored candidate action with the highest score, the selecting resulting in a selected scored candidate action. An embodiment includes causing implementation of the instruction corresponding to the selected scored candidate action.

This application claims the benefit of U.S. Provisional Application No. 63/742325, filed on January 6, 2025, which is incorporated herein in its entirety.

### TECHNICAL FIELD

The present disclosure generally relates to automated workflows, and more particularly to context-based strategy generation and implementation.

### BACKGROUND

One use case for an automated workflow is a go-to-market (GTM) strategy, an organization’s plan, utilizing internal and external (e.g., retail outlets or distributors) to deliver the organization's value proposition to customers, including creating and implementing a marketing strategy for a product or service. GTM strategies are typically complex. Companies face challenges in managing the many tasks involved in GTM efforts, such as identifying the right audience, creating effective outreach content, tracking engagement, and optimizing actions over time. GTM strategies vary in effectiveness, making it difficult for companies to predict outcomes such as email replies or lead generation from content like blog posts and social media. Presently available GTM strategies often require human involvement to monitor, analyze, and tweak marketing and sales strategies and operations, as well as searching through, analyzing, and utilizing data for decision making, which is both time-consuming and costly. Presently available GTM strategies often rely on predefined, static workflows, failing to learn from past outcomes or adapt quickly to changing conditions in the marketplace or audience behavior. Personalizing content for various audiences is inefficient, and optimizing resource allocation across marketing channels is challenging. Companies struggle to extract meaningful insights from large, complex datasets, including unstructured information like customer interactions and preferences. Thus, the illustrative embodiments recognize that there is an unmet need for an automated manner of providing context-based strategy generation and implementation, that is data-driven, adapts to changing marketplace conditions or audience behavior, and minimizes human involvement.

### SUMMARY

Some embodiments of the present disclosure provide a computer-implemented method for context-based strategy generation and implementation. The method includes generating, using a trained planning model and a context, an instruction implementing each candidate action in a plurality of candidate actions, the plurality of candidate actions selected by the trained planning model from a plurality of predefined actions; generating, from the instruction, using a trained generator model and the context, an implementation of each instruction; scoring, using a trained reward model, each candidate action in the plurality of candidate actions, the scoring resulting in a plurality of scored candidate actions; selecting, from the plurality of scored candidate actions, a scored candidate action with the highest score, the selecting resulting in a selected scored candidate action; and causing implementation of the instruction corresponding to the selected scored candidate action.

Some embodiments of the present disclosure provide a non-transitory computer-readable medium storing a program for context-based strategy generation and implementation. The program, when executed by a computer, configures the computer to generate, using a trained planning model and a context, an instruction implementing each candidate action in a plurality of candidate actions, the plurality of candidate actions selected by the trained planning model from a plurality of predefined actions; generate, from the instruction, using a trained generator model and the context, an implementation of each instruction; score, using a trained reward model, each candidate action in the plurality of candidate actions, the scoring resulting in a plurality of scored candidate actions; select, from the plurality of scored candidate actions, a scored candidate action with the highest score, the selecting resulting in a selected scored candidate action; and cause implementation of the instruction corresponding to the selected scored candidate action.

Some embodiments of the present disclosure provide a system for context-based strategy generation and implementation. The system comprises a processor and a non-transitory computer readable medium storing a set of instructions, which when executed by the processor, configure the processor to generate, using a trained planning model and a context, an instruction implementing each candidate action in a plurality of candidate actions, the plurality of candidate actions selected by the trained planning model from a plurality of predefined actions; generate, from the instruction, using a trained generator model and the context, an implementation of each instruction; score, using a trained reward model, each candidate action in the plurality of candidate actions, the scoring resulting in a plurality of scored candidate actions; select, from the plurality of scored candidate actions, a scored candidate action with the highest score, the selecting resulting in a selected scored candidate action; and cause implementation of the instruction corresponding to the selected scored candidate action.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement context-based strategy generation and implementation, according to some embodiments.

FIG. 2 is a block diagram illustrating details of a system for context-based strategy generation and implementation, according to some embodiments.

FIG. 3 depicts a block diagram of an example configuration for context-based strategy generation and implementation, in accordance with an illustrative embodiment.

FIG. 4 depicts execution flow in an example of context-based strategy generation and implementation, in accordance with an illustrative embodiment.

FIG. 5 depicts an example of reward model computation in context-based strategy generation and implementation, in accordance with an illustrative embodiment.

FIG. 6 depicts a flowchart of an example process for context-based strategy generation and implementation. in accordance with an illustrative embodiment.

FIG. 7 depicts another example of context-based strategy generation and implementation, in accordance with an illustrative embodiment.

FIG. 8 depicts another example of context-based strategy generation and implementation, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing context-based strategy generation and implementation. In particular, an embodiment generates, using a trained planning model and a context, an instruction implementing each candidate action in a plurality of candidate actions, the plurality of candidate actions selected by the trained planning model from a plurality of predefined actions; generates, from the instruction, using a trained generator model and the context, an implementation of each instruction; scores, using a trained reward model, each candidate action in the plurality of candidate actions, the scoring resulting in a plurality of scored candidate actions; selects, from the plurality of scored candidate actions, a scored candidate action with the highest score, the selecting resulting in a selected scored candidate action; and causes implementation of the instruction corresponding to the selected scored candidate action.

An embodiment receives a query, i.e., a request to perform a task. One non-limiting example of a query is to generate a marketing campaign for Product A. A query can be one-time or periodic (e.g., perform this task every Monday morning), and optionally triggered by an event (e.g., if April sales of Product A are below a predetermined threshold, an early May query might be to generate additional promotions aimed at improving sales of Product A). A query can be a part of a larger workflow. For example, consider a case where a user wishes to implement an entire marketing campaign, beginning with queries to identify a specific industry, region, and product to target (e.g., by generating actions that query specific databases). Once an audience is defined, the next query might be to research every target or generate instructions to message each one, or trigger a pre-defined action that runs over a set of leads. In some embodiments, portions of a workflow execute in parallel.

An embodiment also has access to a context, or context data, i.e., data that is a context for a query, and is usable to make decisions implementing a task in a query. For example, in GTM activity, a sender is a marketer of a product or service, and a target is a potential or actual customer of a product or service. Thus, components of a context are sender data (e.g., data describing a product or service to be marketed) and target data (e.g., data describing a target’s business model and products or services the target has bought or is expected to buy, and the like), and an interaction history between sender and target. A context also includes an external context, i.e., data that is not specifically related to the sender or target. Some non-limiting examples of an external context are weather, economic data, and political events. Context data is multi-modal, for example including one or more of natural language or structured text, structured data (e.g., in numerical or tabular form), still images, video, audio, interaction data such as meetings or telephone calls, and the like.

Using a trained planning model and a context, an embodiment generates a plurality of candidate actions and an instruction implementing each candidate action. One embodiment generates sequences of actions and one or more instructions implementing each action in a sequence. In one embodiment, the planning model has access to a plurality of predefined actions, also referred to as a playbook, and selects candidate actions from the predefined actions. In another embodiment, the planning model generates candidate actions. In another embodiment, the planning model both generates candidate actions and selects from already-defined candidate actions. Actions are tasks used to implement a query, and instructions instruct another model to generate an implementation of a task. Actions span a spectrum between simple (such as individual API calls or clicking a particular button or link in a web browser) to more complex (such as entire workflows, e.g., pick an audience, then generate email campaigns, personalize each message in each email campaign, then orchestrate sending the messages over the next few weeks). Some non-limiting examples of actions, in a GTM space, are “describe pain points and how this product solves them” “generate statistics on the value of Product A”, “attend a webinar”, and “offer a discount”. An action also includes parameters describing particulars of the action, for example contextual information to be used writing an email, the email’s theme or tone, and the contents of a database query. For example, for an input query asking to generate a marketing campaign for Product A, candidate actions might be to generate emails to each of the ten highest-ranked existing buyers of the predecessor to Product A, and an example instruction implementing one of the candidate actions might be “generate an email to Customer A, in a friendly tone, reminding Customer A of their success reselling Product A’s predecessor, announcing that Product A is now available, and listing new features in Product A.” Another example instruction implementing another candidate action might be the same as for Customer A, only target Customer B instead. Another example instruction implementing another candidate action might target Customer C and omit the mention of previous sales (because Customer C did not sell Product A’s predecessor).

In some embodiments, the trained planning model is a presently available large language model (LLM). An LLM is a type of computational model, typically implemented using an artificial neural network, designed for natural language processing tasks such as language generation. LLMs acquire these abilities by learning statistical relationships from text documents during a self-supervised and semi-supervised training process. An input to an LLM is also referred to as a prompt. For example, a prompt asking the planning model to select a plurality of candidate actions might be “please choose from following actions given the following context”, followed by predefined candidate actions to select from and a context including context data. In other embodiments, the trained planning model uses other presently available techniques, such as chain-of-thought reasoning or Monte Carlo tree search.

An embodiment uses a trained generator model and the context to generate an instruction implementation, or implementation, from an instruction. An implementation implements an instruction. For example, if an instruction is “generate an email to Customer A, in a friendly tone, reminding Customer A of their success reselling Product A’s predecessor, announcing that Product A is now available, and listing new features in Product A,” a corresponding implementation might be the email to Customer A with the desired characteristics. As another example, if an instruction was to generate a marketing video for Product B, highlighting a specified set of features of Product B, a corresponding implementation might be the requested video. Techniques to generate content such as natural language text or video, computer source code, and implement other instructions, are presently available. Some embodiments use multiple trained generator models, with each generator model implementing generation of a specific type of content or a specific type of instruction, in series or in parallel. For example, an embodiment might use one trained generator model to produce natural language text, and another trained generator model to produce a video (optionally using a script generated using the text generator model. Some embodiments include a combined planning and generator model, while other embodiments include separate planning and generator models.

Using a trained reward model, an embodiment scores each candidate action in the plurality of candidate actions. To score a candidate action, an embodiment uses one or more presently available techniques, as well as available context data. For example, to score a candidate action of evaluating Target B as a marketing prospect for Product B, an embodiment might use a fit classifier and context data of the sender and Target B to classify Target B into a “yes” or a “no” category. As another example, for a candidate action of generating an initial marketing email marketing Product B to Target B with specific parameters, an embodiment might use a message classifier and context data to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique. As another example, for a candidate action of generating a follow-up marketing email marketing Product B to Target B with specific parameters, an embodiment might use a message classifier and context data to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique. Note that classifiers classify into a category based on an output score’s relationship to one or more category defining thresholds. For example, for a choice between “yes” and “no” categories, a classifier might output a “yes” if an output score is above a predefined threshold (e.g., 0.5 in a 0-1 range) and output a “no” otherwise. Other scoring techniques, using presently available techniques other than classifiers, are also possible and contemplated within the scope of the illustrative embodiments.

An embodiment selects, from the plurality of scored candidate actions, a scored candidate action with the highest score, and causes implementation of the instruction corresponding to the selected scored candidate action. For example, if the scored candidate actions were to generate an initial email marketing message to each of Target A, B, C, and D, and the message to Target A scored highest, an embodiment might select the email to Target A and cause the generated email to be sent to Target A.

An embodiment uses a result of an instruction implementation to adjust or further train the planning model, the reward model, or both, using a presently available model training technique. An embodiment obtains a result of an instruction implementation using a presently available method. For example, if an action was to generate a marketing email to Target A, and Target A did not respond, an embodiment might use this data point in model training. Some non-limiting examples of presently available model training techniques are reinforcement learning using outputs of the reward model, Direct Preference Optimization (DPO) for fine-tuning an LLM, reinforcement learning from human feedback (RLHF), a technique to align an intelligent agent with human preferences by training a reward model to represent preferences, and Reinforcement Fine Tuning, a model fine tuning method that trains a model to perform reasoning with regards to the task at hand.

Embodiments described herein need not be limited to GTM-related use cases. In another example use case, a trained planning model uses a context to prioritize candidates and generate other actions from a database of prospective employees (e.g., sourced by searching publicly available data for key phrases, similar employers, or a natural language search), a trained generator model implements actions generated by the planning model, and a reward model evaluates results of the actions for further model training. In another example use case, navigating one or more sites to answer research questions, a trained planning model uses a starting point (e.g., an initial Uniform Resource Locator, or URL) and context data to generate actions, such as additional URLs to visit and summarize, a trained generator model implements the generated actions, and a trained reward model evaluates results for additional searching and model training. In another example use case, based on descriptions and/or examples of an ideal customer profile (ICP), an agent formulates and refines a search for companies that meet the ICP, prioritizes them for targeting, as well as performs qualification based on descriptions, attributes, or research of the company or lead.

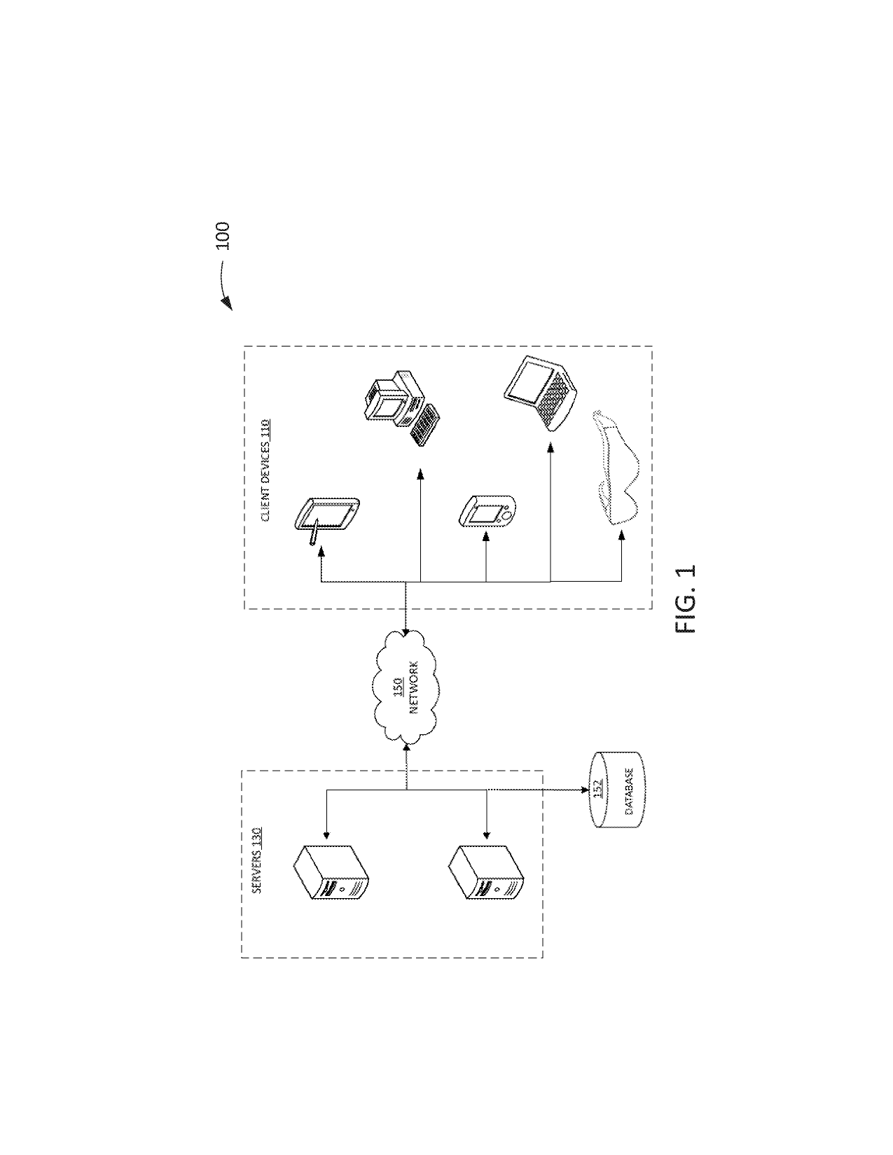

FIG. 1 illustrates a network architecture 100 used to implement context-based strategy generation and implementation, according to some embodiment. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

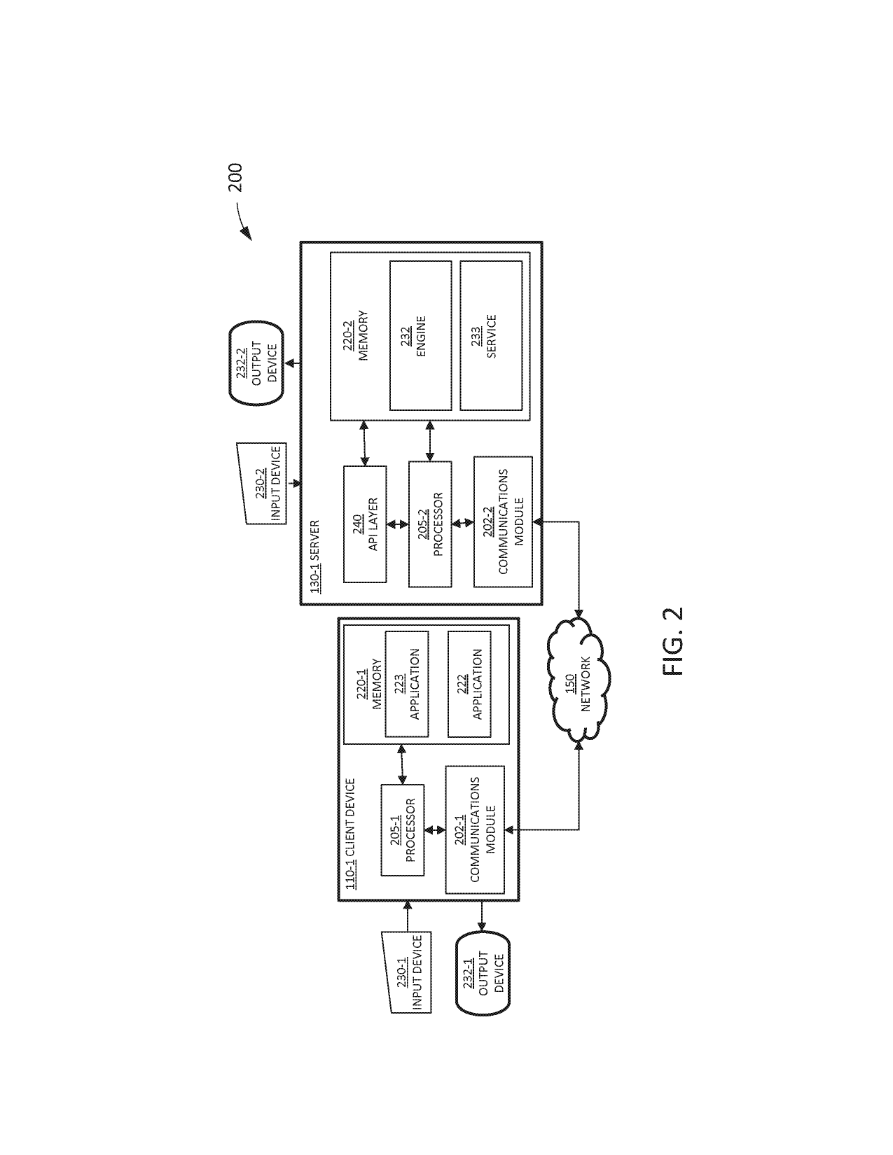

FIG. 2 is a block diagram illustrating details of a system 200 for context-based strategy generation and implementation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement context-based strategy generation and implementation. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide context-based strategy generation and implementation. The application 223 may communicate with service 233 through API layer 240, for example.

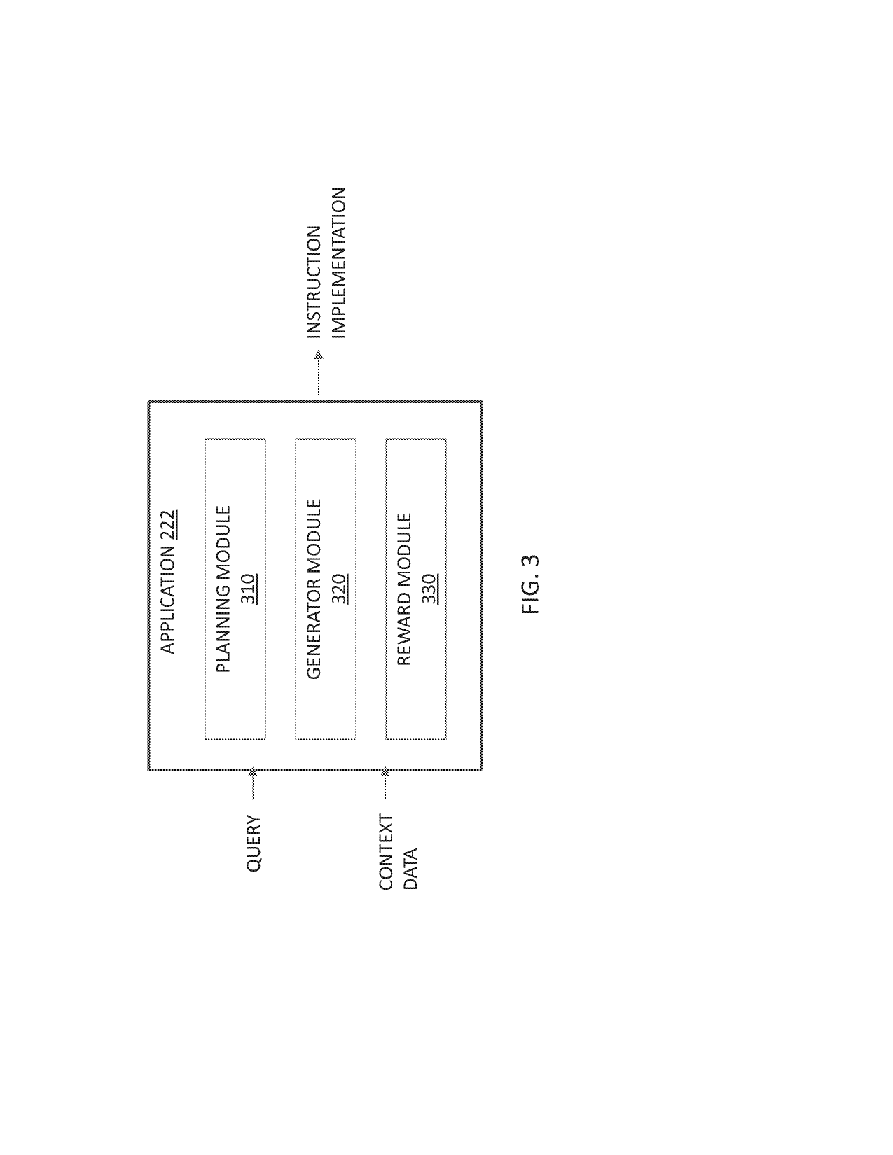

FIG. 3 depicts a block diagram of an example configuration for context-based strategy generation and implementation, in accordance with an illustrative embodiment. Application 222 is the same as application 222 in FIG. 2.

Application 222 receives a query, i.e., a request to perform a task. One non-limiting example of a query is to generate a marketing campaign for Product A. A query can be one-time or periodic (e.g., perform this task every Monday morning), and optionally triggered by an event (e.g., if April sales of Product A are below a predetermined threshold, an early May query might be to generate additional promotions aimed at improving sales of Product A). A query can be a part of a larger workflow. For example, consider a case where a user wishes to implement an entire marketing campaign, beginning with queries to identify a specific industry, region, and product to target (e.g., by generating actions that query specific databases). Once an audience is defined, the next query might be to research every target or generate instructions to message each one, or trigger a pre-defined action that runs over a set of leads. In some implementations of application 222, portions of a workflow execute in parallel.

Application 222 also has access to a context, or context data, i.e., data that is a context for a query, and is usable to make decisions implementing a task in a query. For example, in GTM activity, a sender is a marketer of a product or service, and a target is a potential or actual customer of a product or service. Thus, components of a context are sender data (e.g., data describing a product or service to be marketed) and target data (e.g., data describing a target’s business model and products or services the target has bought or is expected to buy, and the like), and an interaction history between sender and target. A context also includes an external context, i.e., data that is not specifically related to the sender or target. Some non-limiting examples of an external context are weather, economic data, and political events. Context data is multi-modal, for example including one or more of natural language or structured text, structured data (e.g., in numerical or tabular form), still images, video, audio, interaction data such as meetings or telephone calls, and the like.

Using a trained planning model and a context, planning module 310 generates a plurality of candidate actions and an instruction implementing each candidate action. One implementation of module 310 generates sequences of actions and one or more instructions implementing each action in a sequence. In one implementation of module 310, the planning model has access to a plurality of predefined actions, also referred to as a playbook, and selects candidate actions from the predefined actions. In another implementation of module 310, the planning model generates candidate actions. In another implementation of module 310, the planning model both generates candidate actions and selects from already-defined candidate actions. Actions are tasks used to implement a query, and instructions instruct another model to generate an implementation of a task. Actions span a spectrum between simple (such as individual API calls or clicking a particular button or link in a web browser) to more complex (such as entire workflows, e.g., pick an audience, then generate email campaigns, personalize each message in each email campaign, then orchestrate sending the messages over the next few weeks). Some non-limiting examples of actions, in a GTM space, are “describe pain points and how this product solves them” “generate statistics on the value of Product A”, “attend a webinar”, and “offer a discount”. An action also includes parameters describing particulars of the action, for example contextual information to be used writing an email, the email’s theme or tone, and the contents of a database query. For example, for an input query asking to generate a marketing campaign for Product A, candidate actions might be to generate emails to each of the ten highest-ranked existing buyers of the predecessor to Product A, and an example instruction implementing one of the candidate actions might be “generate an email to Customer A, in a friendly tone, reminding Customer A of their success reselling Product A’s predecessor, announcing that Product A is now available, and listing new features in Product A.” Another example instruction implementing another candidate action might be the same as for Customer A, only target Customer B instead. Another example instruction implementing another candidate action might target Customer C and omit the mention of previous sales (because Customer C did not sell Product A’s predecessor).

In some implementations of module 310, the trained planning model is a presently available large language model (LLM). An LLM is a type of computational model, typically implemented using an artificial neural network, designed for natural language processing tasks such as language generation. LLMs acquire these abilities by learning statistical relationships from text documents during a self-supervised and semi-supervised training process. An input to an LLM is also referred to as a prompt. For example, a prompt asking the planning model to select a plurality of candidate actions might be “please choose from following actions given the following context”, followed by predefined candidate actions to select from and a context including context data. In other embodiments, the trained planning model uses other presently available techniques, such as chain-of-thought reasoning or Monte Carlo tree search.

Generator module 320 uses a trained generator model and the context to generate an instruction implementation, or implementation, from an instruction. An implementation implements an instruction. For example, if an instruction is “generate an email to Customer A, in a friendly tone, reminding Customer A of their success reselling Product A’s predecessor, announcing that Product A is now available, and listing new features in Product A,” a corresponding implementation might be the email to Customer A with the desired characteristics. As another example, if an instruction was to generate a marketing video for Product B, highlighting a specified set of features of Product B, a corresponding implementation might be the requested video. Techniques to generate content such as natural language text or video, computer source code, and implement other instructions, are presently available. Some implementations of module 320 use multiple trained generator models, with each generator model implementing generation of a specific type of content or a specific type of instruction, in series or in parallel. For example, module 320 might use one trained generator model to produce natural language text, and another trained generator model to produce a video (optionally using a script generated using the text generator model. Some implementations of application 222 include a combined planning and generator model, while other embodiments include separate planning and generator models.

Using a trained reward model, reward module 330 scores each candidate action in the plurality of candidate actions. To score a candidate action, module 330 uses one or more presently available techniques, as well as available context data. For example, to score a candidate action of evaluating Target B as a marketing prospect for Product B, module 330 might use a fit classifier and context data of the sender and Target B to classify Target B into a “yes” or a “no” category. As another example, for a candidate action of generating an initial marketing email marketing Product B to Target B with specific parameters, module 330 might use a message classifier and context data to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique. As another example, for a candidate action of generating a follow-up marketing email marketing Product B to Target B with specific parameters, module 330 might use a message classifier and context data to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique. Note that classifiers classify into a category based on an output score’s relationship to one or more category defining thresholds. For example, for a choice between “yes” and “no” categories, a classifier might output a “yes” if an output score is above a predefined threshold (e.g., 0.5 in a 0-1 range) and output a “no” otherwise. Other scoring techniques, using presently available techniques other than classifiers, are also possible and contemplated within the scope of the illustrative embodiments.

Module 330 selects, from the plurality of scored candidate actions, a scored candidate action with the highest score, and causes implementation of the instruction corresponding to the selected scored candidate action. For example, if the scored candidate actions were to generate an initial email marketing message to each of Target A, B, C, and D, and the message to Target A scored highest, module 330 might select the email to Target A and cause the generated email to be sent to Target A.

Application 222 uses a result of an instruction implementation to adjust or further train the planning model, the reward model, or both, using a presently available model training technique. Application 222 obtains a result of an instruction implementation using a presently available method. For example, if an action was to generate a marketing email to Target A, and Target A did not respond, application 222 might use this data point in model training. Some non-limiting examples of presently available model training techniques are reinforcement learning using outputs of the reward model, Direct Preference Optimization (DPO) for fine-tuning an LLM, reinforcement learning from human feedback (RLHF), a technique to align an intelligent agent with human preferences by training a reward model to represent preferences, and Reinforcement Fine Tuning, a model fine tuning method that trains a model to perform reasoning with regards to the task at hand.

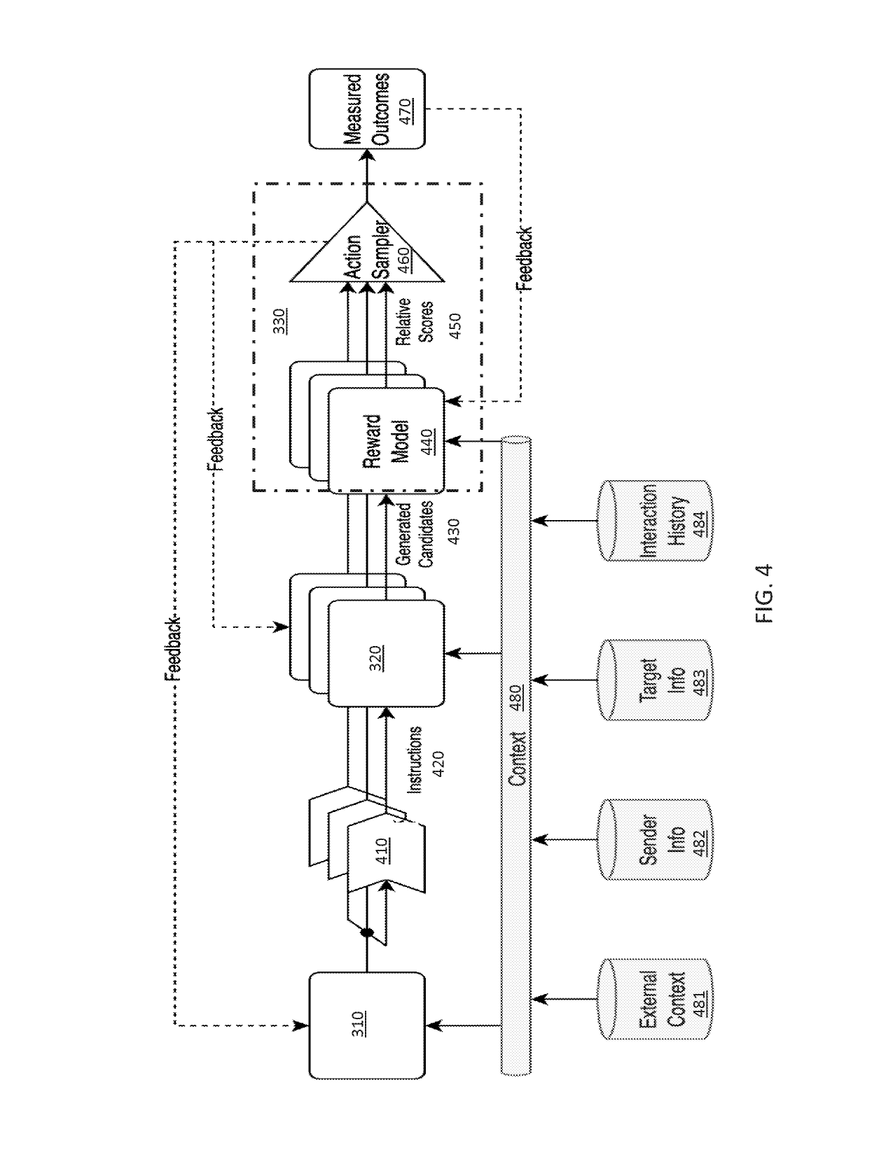

FIG. 4 depicts an example of context-based strategy generation and implementation, in accordance with an illustrative embodiment. Planning module 310, generator module 320, and reward module 330 are the same as planning module 310, generator module 320, and reward module 330 in FIG. 3. The example can be executed using application 222 in FIG. 2.

Planning module 310 uses a trained planning model and context 480 (including external context 481, sender information 482, target information 483, and interaction history 484) to generate candidate actions 410 and instructions 420 implementing each candidate action. Generator module 320 uses a trained generator model and context 480 to generate generated candidates 430, each of which is an implementation of an instruction in instructions 420. Using trained reward model 440, reward module 330 scores generated candidates 430, resulting in relative scores 450. Action sampler 460 selects one of generated candidates 430 with the highest score and causes implementation of the instruction corresponding to the selected scored candidate action. Application 222 measures a result of the implemented action (represented by measured outcomes 470). Application 222 uses measured outcomes 470 to adjust or further train the planning model, the reward model, or both.

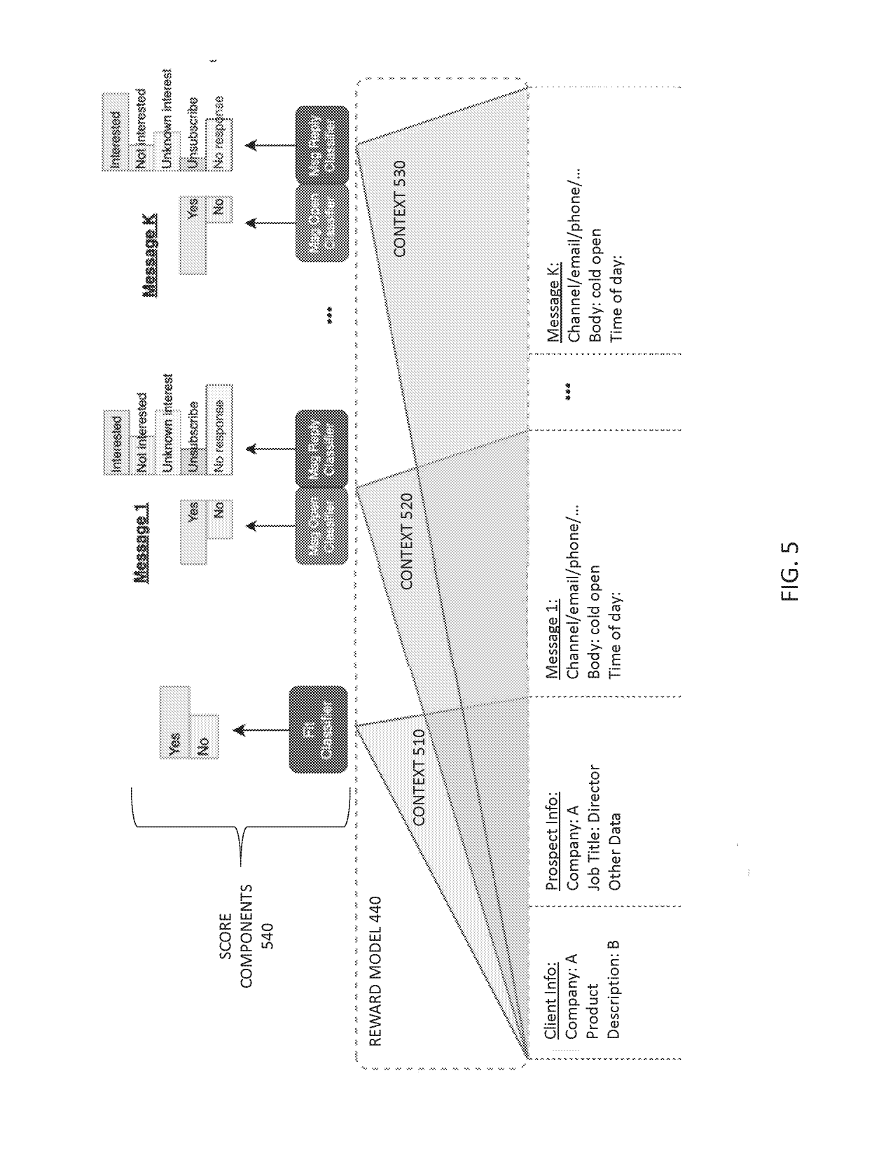

FIG. 5 depicts another example of context-based strategy generation and implementation, in accordance with an illustrative embodiment. The example can be executed using application 222 in FIG. 2. Reward module 440 is the same as reward module 440 in FIG. 4.

In particular, FIG. 5 depicts example scoring (i.e., score components 540) generated by reward model 440. For example, to score a candidate action of evaluating Target B as a marketing prospect for Product B, reward model 440 might use a fit classifier and context 510 (context data of the sender and Target B) to classify Target B into a “yes” or a “no” category. As another example, for a candidate action of generating an initial marketing email marketing Product B to Target B with specific parameters, reward model 440 might use a message classifier and context 520 to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique. As another example, for a candidate action of generating a follow-up marketing email marketing Product B to Target B with specific parameters, reward model 440 might use a message classifier and context 530 to classify a likelihood that Target B will open the email into a “yes” or a “no” category, use a message reply classifier to classify Target B’s response to the email into categories such as “interested”, “not interested”, “unknown interest”, “unsubscribe” (i.e., Target B unsubscribes from marketing emails), and “no response”, and combine the classification results into a score using a presently available technique.

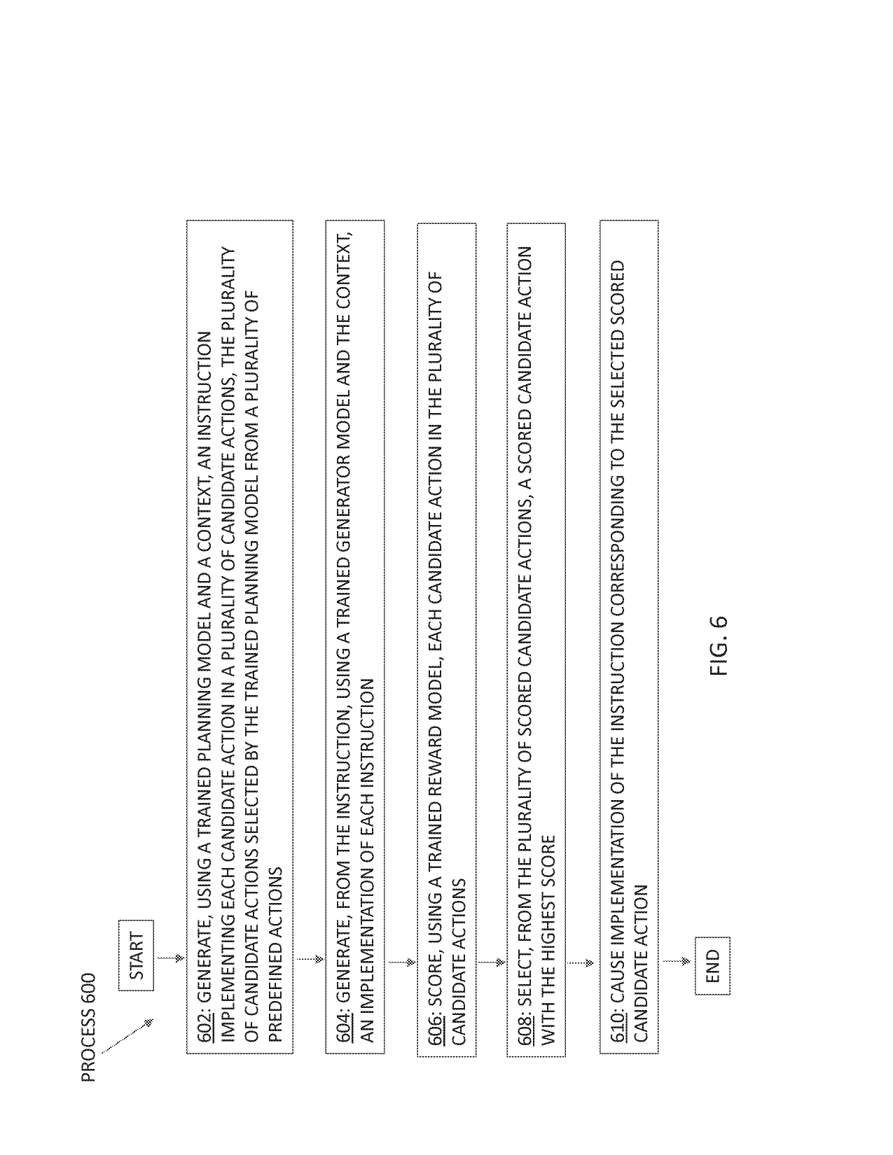

FIG. 6 depicts a flowchart of an example process for context-based strategy generation and implementation, in accordance with an illustrative embodiment. Process 600 can be implemented in application 222 in FIG. 2.

At block 602, the process generates, using a trained planning model and a context, an instruction implementing each candidate action in a plurality of candidate actions, the plurality of candidate actions selected by the trained planning model from a plurality of predefined actions. At block 604, the process generates, from the instruction, using a trained generator model and the context, an implementation of each instruction. At block 606, the process scores, using a trained reward model, each candidate action in the plurality of candidate actions. At block 608, the process selects, from the plurality of scored candidate actions, a scored candidate action with the highest score. At block 610, the process causes implementation of the instruction corresponding to the selected scored candidate action. Then the process ends.

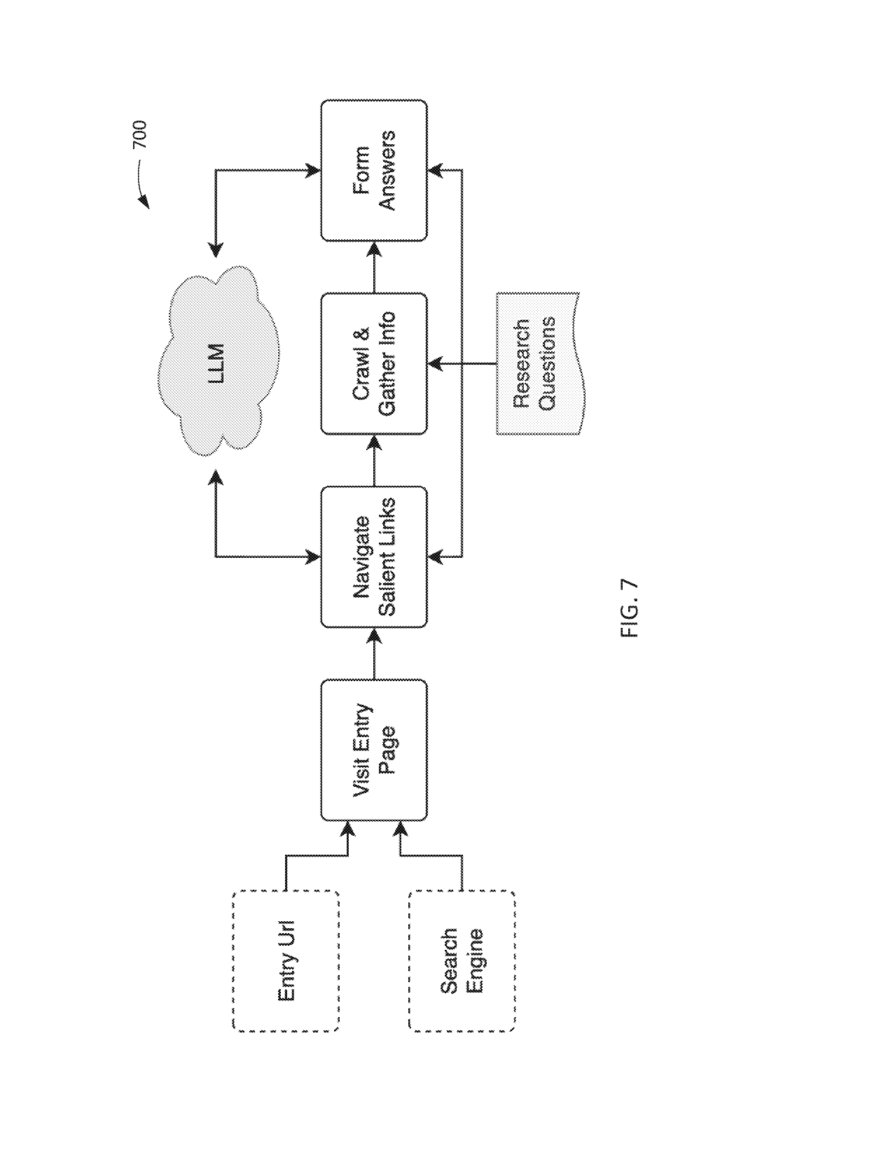

FIG. 7 depicts another example of context-based strategy generation and implementation, in accordance with an illustrative embodiment. The example can be executed using application 222 in FIG. 2. In particular, FIG. 7 depicts execution flow 700, an example use case of navigating one or more sites to answer research questions, in which a trained planning model uses a starting point (e.g., an initial Uniform Resource Locator, or URL) and context data to generate actions, such as additional URLs to visit and summarize, a trained generator model implements the generated actions, and a trained reward model evaluates results for additional searching and model training.

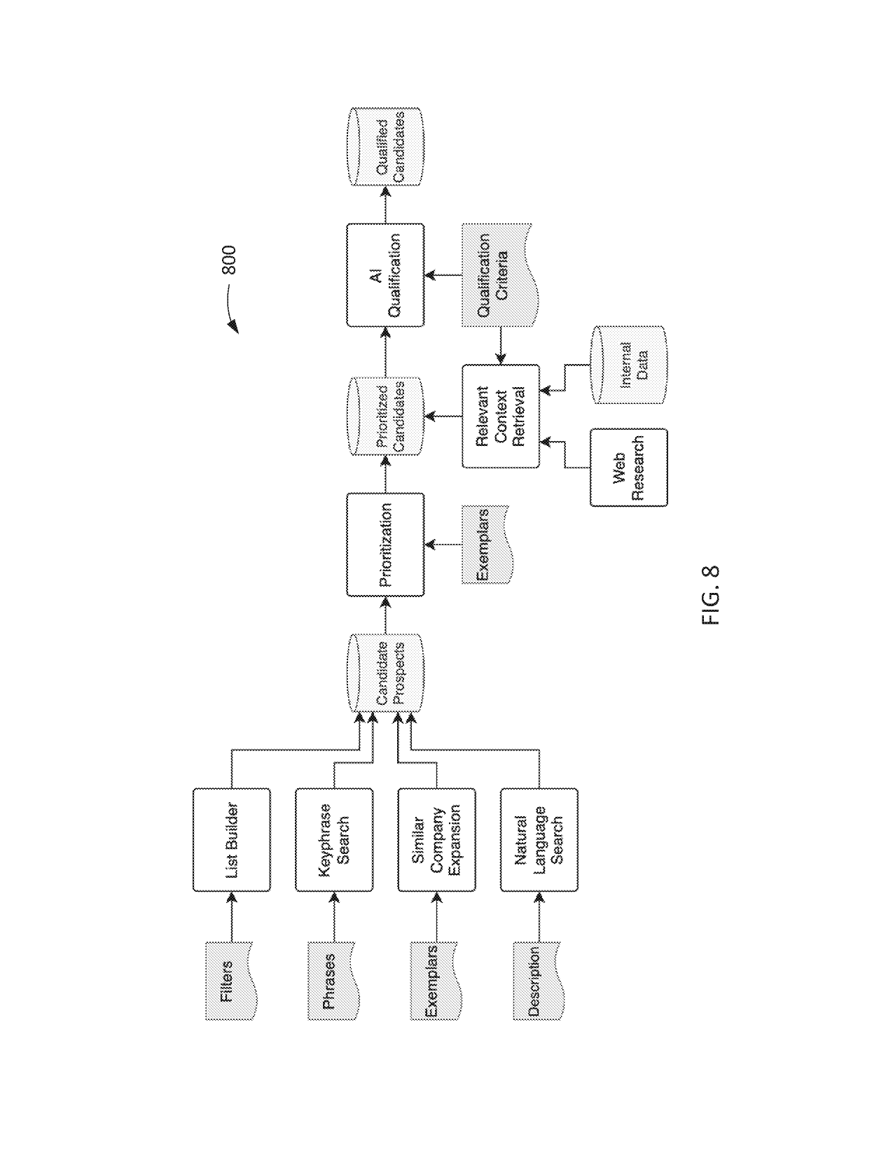

FIG. 8 depicts another example of context-based strategy generation and implementation, in accordance with an illustrative embodiment. The example can be executed using application 222 in FIG. 2. In particular, FIG. 8 depicts execution flow 800, an example use case in which, based on descriptions and/or examples of an ideal customer profile (ICP), an agent formulates and refines a search for companies that meet the ICP, prioritizes them for targeting, as well as performs qualification based on descriptions, attributes, or research of the company or lead.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
generating, using a trained planning model and a context, an instruction implementing each candidate action in a plurality of candidate actions, the plurality of candidate actions selected by the trained planning model from a plurality of predefined actions;
generating, from the instruction, using a trained generator model and the context, an implementation of each instruction;
scoring, using a trained reward model, each candidate action in the plurality of candidate actions, the scoring resulting in a plurality of scored candidate actions;
selecting, from the plurality of scored candidate actions, a scored candidate action with the highest score, the selecting resulting in a selected scored candidate action; and
causing implementation of the instruction corresponding to the selected scored candidate action.

2. The computer-implemented method of claim 1, further comprising:
generating, using the trained planning model, a first candidate action; and
adding, to the plurality of candidate actions, the first candidate action.

3. The computer-implemented method of claim 1, wherein each candidate action in the plurality of candidate actions comprises a task usable to implement a received query.

4. The computer-implemented method of claim 3, wherein the instruction comprises an instruction to a model to generate an implementation of the task.

5. The computer-implemented method of claim 1, wherein each candidate action in the plurality of candidate actions comprises a parameter describing the candidate action.

6. The computer-implemented method of claim 1, wherein the plurality of candidate actions is a sequence of candidate actions.

7. The computer-implemented method of claim 1, wherein the trained planning model is a large language model.

8. The computer-implemented method of claim 1, further comprising:
selecting, from a plurality of type-specific generator models according to a content type specified in the instruction, the trained generator model, wherein each type-specific generator model in the plurality of type-specific generator models is trained to generate a specific type of content.

9. The computer-implemented method of claim 1, further comprising:
further training, using a result of the implementation of the instruction, the trained planning model.

10. The computer-implemented method of claim 1, further comprising:
further training, using a result of the implementation of the instruction, the trained reward model.

11. A non-transitory computer-readable medium storing a program, which when executed by a computer, configures the computer to:
generate, using a trained planning model and a context, an instruction implementing each candidate action in a plurality of candidate actions, the plurality of candidate actions selected by the trained planning model from a plurality of predefined actions;
generate, from the instruction, using a trained generator model and the context, an implementation of each instruction;
score, using a trained reward model, each candidate action in the plurality of candidate actions, the scoring resulting in a plurality of scored candidate actions;
select, from the plurality of scored candidate actions, a scored candidate action with the highest score, the selecting resulting in a selected scored candidate action; and
cause implementation of the instruction corresponding to the selected scored candidate action.

12. The non-transitory computer-readable medium of claim 11, wherein the program, when executed by the computer, further configures the computer to:
generate, using the trained planning model, a first candidate action; and
add, to the plurality of candidate actions, the first candidate action.

13. The non-transitory computer-readable medium of claim 11, wherein each candidate action in the plurality of candidate actions comprises a task usable to implement a received query.

14. The non-transitory computer-readable medium of claim 13, wherein the instruction comprises an instruction to a model to generate an implementation of the task.

15. The non-transitory computer-readable medium of claim 11, wherein each candidate action in the plurality of candidate actions comprises a parameter describing the candidate action.

16. The non-transitory computer-readable medium of claim 11, wherein the plurality of candidate actions is a sequence of candidate actions.

17. The non-transitory computer-readable medium of claim 11, wherein the trained planning model is a large language model.

18. The non-transitory computer-readable medium of claim 11, wherein the program, when executed by the computer, further configures the computer to:
select, from a plurality of type-specific generator models according to a content type specified in the instruction, the trained generator model, wherein each type-specific generator model in the plurality of type-specific generator models is trained to generate a specific type of content.

19. The non-transitory computer-readable medium of claim 11, wherein the program, when executed by the computer, further configures the computer to:
further train, using a result of the implementation of the instruction, the trained planning model.

20. A system comprising:
a processor; and
a non-transitory computer readable medium storing a set of instructions, which when executed by the processor, configure the system to:
generate, using a trained planning model and a context, an instruction implementing each candidate action in a plurality of candidate actions, the plurality of candidate actions selected by the trained planning model from a plurality of predefined actions;
generate, from the instruction, using a trained generator model and the context, an implementation of each instruction;
score, using a trained reward model, each candidate action in the plurality of candidate actions, the scoring resulting in a plurality of scored candidate actions;
select, from the plurality of scored candidate actions, a scored candidate action with the highest score, the selecting resulting in a selected scored candidate action; and
cause implementation of the instruction corresponding to the selected scored candidate action.
